(19) United States
(12) Patent Application Publication
(10) Pub. No.: US 2025/0362150 A1
(43) Pub. Date: Nov. 27, 2025

(54) LANE BOUNDARY SEGMENT GENERATION

(71) Applicant: Pony.ai, Inc., Fremont, CA (US)

(72) Inventors: Yuqian Li, Mountain View, CA (US); Lear Du, San Jose, CA (US)

(21) Appl. No.: 18/671,960

(22) Filed: May 22, 2024

(51) Int. Cl. G01C 21/00; G01C 21/34

(52) U.S. Cl. CPC G01C 21/3822; G01C 21/34

(57) ABSTRACT

A system includes one or more processors that obtain data from one or more sources. The sources include sources any of low resolution map data, historical data of an ego-vehicle position, and landmark data. The processors generate candidate segments indicative of potential lane boundaries, the candidate segments include any of a first candidate segment generated from the low resolution map data, a second candidate segment generated from the historical data of the ego-vehicle position, and a third candidate segment generated from the landmark data. The processors validate the generated candidate segments, align the validated and generated one or more candidate segments, and construct a segment based on the aligned, validated, and generated one or more candidate segments, the segment defining a lane boundary. The segment is used to compute a navigation path for the ego-vehicle to operate the ego-vehicle within the lane boundary defined by the segment.

### BACKGROUND

By 2040, an anticipated 75 percent of vehicles will be autonomous or semi-autonomous, according to the Institute of Electrical and Electronics Engineers (IEEE). The rapid proliferation of autonomous or semi-autonomous vehicles has increased an urgency for safety verification and transparency of decision making of these vehicles. Safety of autonomous vehicles is a paramount concern because any safety deficiencies may potentially result in grave consequences.

A major challenge in autonomous or semi-autonomous driving is maintaining an ego-vehicle (e.g., currently operating vehicle) within a lane, boundary, other demarcation, or permitted region. Landmarks or lane boundary lines may be unclear or absent, especially within intersections. High-definition maps represent a road environment with centimeter-level precision and lane-level semantic information. However, map data from high-definition maps may be limited, inaccurate, or unavailable. Many standard maps such as low-resolution maps and standard-definition maps only have road-level information without any specific details regarding lane information. Additionally, even the road-level information may be inaccurate or out-of-date. Therefore, it is insufficient to use only landmarks or only standard maps to maintain an ego-vehicle within a lane.

### SUMMARY

A claimed solution rooted in computer technology overcomes problems such as safely maintaining an ego-vehicle, which may include a semi-autonomous or autonomous vehicle, within a lane or other pathway on a road. The claimed solution overcomes limitations of unclear or unavailable lane markings, and/or limited or unavailable existing map data. Embodiments of the present invention implement a computing system that implements a comprehensive approach to reliably and accurately generate segments, markings, trajectories, or curves (hereinafter “segments”) that correspond to lane boundaries or demarcations. These segments may be located at a current and/or predicted or scheduled future position of the ego-vehicle. Therefore, the computing system, or a different computing system, may perform current navigation or actuation actions or schedule future navigation actions on the ego-vehicle based on the segments by controlling the current or future position of the ego-vehicle to be within permitted lanes as defined by the segments.

The computing system may generate one or more candidate segments, markings, trajectories, or curves (hereinafter “segments”), validate at least a portion of the one or more candidate segments, align the validated candidate segments, and construct one or more segments according to the aligned and validated candidate segments. The aligned and validated candidate segments may refer to or be located within a particular common location or region (hereinafter “region”). The constructed segments are actually used to guide navigation. Each candidate and/or constructed segment may be defined or represented according to a set of latitude and longitude coordinates. In some embodiments, each candidate and/or constructed segment may be represented by a parametric curve (x(s), y(s)), where s represents a position or length along the parametric curve. A value of the relative “s” parameter being zero may indicate a current position or a starting position of the ego-vehicle. In some embodiments, the (x(s), y(s)) coordinates may indicate latitude and longitude coordinates, respectively, or be derived from a one-to-one mapping from the latitude and longitude coordinates.

The computing system may present or display the one or more constructed segments on a navigation map, and/or other system or interface that guides navigation. In some embodiments, the computing system may overlay the constructed segments onto a navigation map. In some embodiments, the computing system may replace any existing segments on the navigation map, which may be less reliable compared to the constructed segments. In some embodiments, the computing system may use the one or more constructed segments to compute a navigation path for the ego vehicle and to trigger actuation of the ego-vehicle according to the computed navigation path. In some embodiments, the computing system may provide the one or more constructed segments to a different vehicle system such as a navigation and/or actuation system. The claimed solution may facilitate reliable navigation even in an absence of high-definition map data. High-definition map data may encompass map data having a precision within an order of centimeters (cm), such as under 10 centimeters (cm), and/or map data that includes a certain degree of lane-level precision.

This comprehensive approach of generating candidate segments based on different sources mitigates or avoids errors from a single source by performing sanity checks across the different sources. The computing system may utilize portions of any of the candidate segments, such as the particular set of corresponding candidate segments, to construct the one or more segments which are actually used to guide navigation. In some embodiments, portions of the particular set of corresponding candidate segments may be combined to construct the segments. The different sources from which the candidate segments are derived or generated may include a low-resolution map or standard-definition map (hereinafter “low-resolution map”), ego-vehicle historical data, and/or landmark data from different sensors such as a camera and/or Lidar. During the generating of the candidate segments, the computing system may capture and modify raw data from the different sources. The validation of the candidate segments may include removing or filtering out erroneous or less reliable data. In some embodiments, the computing system may rank corresponding candidate segments that have been validated and aligned, and select, based on rankings, only a portion of the candidate segments to be incorporated into the one or more segments. Here, a portion of the candidate segments may refer to inclusion of a portion of a particular candidate segment or inclusion of a particular candidate segment in its entirety while excluding a different candidate segment.

In some embodiments, the computing system may generate first candidate segments from low-resolution map data. In some embodiments, because raw data from the low-resolution maps may be sparsely populated, the generating of the first candidate segments may include interpolating between points of the raw data to infer additional data, until a distance between adjacent points is within a threshold distance. In some embodiments, any first candidate segment in which a curvature exceeds a given threshold (e.g., a first threshold curvature) may be removed. Here, a curvature may refer to a second derivative ∂²y/∂x² of the longitude in relation to the latitude. A curvature exceeding a threshold curvature may also refer to a radius of curvature being less than a threshold radius of curvature. Additionally or alternatively, in some embodiments, portions of a first candidate segment that include artifacts such as abrupt changes in curvature, such as zigzags or oscillations, may also be removed. For example, these portions may have a change in curvature from a negative curvature to a positive curvature (e.g., from concave down to concave up), in which the magnitudes or absolute values of the negative curvature and the positive curvature both exceed a given threshold. The given threshold may be equal to the first threshold curvature or may refer to a second threshold curvature. As another example, these portions may have a change in curvature from a positive curvature to a negative curvature (e.g., from concave up to concave down), in which the magnitudes of the positive curvature and the negative curvature both exceed the given threshold. In some examples, these portions also have a rate of change of curvature (e.g., a third derivative ∂³y/∂x³) that exceeds a given threshold rate of change of curvature.

In some embodiments, the computing system may generate second candidate segments from historical positions of the ego-vehicle. Historical positions of the ego-vehicle may include latitude and/or longitude, and be tracked by one or more localization sensors on the ego-vehicle, such as Global Positioning System (GPS) and Inertial Measurement Unit (IMU) data. In some embodiments, the tracking of the historical positions may encompass logging entries that indicate historical positions relative to timestamps. In some embodiments, the log may be manifested as a queue. In some embodiments, the log may include a limited amount of entries, and data may be selectively retained within the log based on recency of the entries. For example, some older entries may be selectively removed from the log in favor of newer entries. In other examples, some older entries may be selectively retained and newer entries may be selectively removed. For example, if a new entry corresponds to a position that is within a threshold distance of a preceding entry, then the new entry may be removed because it indicates that the ego-vehicle has not moved much over a time period between the preceding entry and the new entry. Thus, the log may selectively record entries in which actual movement occurs, rather than repetitive entries which are not useful for generating second candidate segments.

In some embodiments, the computing system may validate the first candidate segments by comparing against corresponding second candidate segments. The computing system may compare lateral distances between corresponding points of the first candidate segments and the second candidate segments. If the lateral distances are consistent between a candidate segment pair (e.g., between a first candidate segment and a corresponding second candidate segment), then the computing system may determine a match between that candidate segment pair. If the lateral distances are inconsistent between the candidate segment pair, then the computing system may determine a mismatch and invalidate the first candidate segment and/or the second candidate segment.

In some embodiments, the computing system may generate third candidate segments based on landmarks as acquired by one or more sensors such as cameras and Lidars. The cameras and Lidars may be located on the ego-vehicle or away from the ego-vehicle. The third candidate segments may be corresponding to locations that are at, or away from, a current location of the ego-vehicle. Landmarks may indicate lane boundaries, curbs, or other demarcations. The computing system may compare the third candidate segments against corresponding first candidate segments. If a third candidate segment has a high quality, as determined by a degree of smoothness and/or consistency, then the third candidate segment may be validated and/or ranked higher compared to the first candidate segment. In some embodiments, if at least a portion of the third candidate segment has a low quality (e.g., a quality below a threshold quality), then the computing system may remove those portions or replace those portions with corresponding portions of the first candidate segments.

In some embodiments, the computing system may align the generated and validated candidate segments, so that a coordinate (x(0), y(0)) of any validated candidate segment refers to the ego-vehicle's current position. To align a generated and validated candidate segment, the computing system may use a first candidate segment as a reference and project either the corresponding second candidate segment or the corresponding third candidate segment onto the first candidate segment. The computing system may compute a relative distance or offset of the second candidate segment or the third candidate segment and adjust at least one of the validated candidate segments to counteract the relative offset.

In some embodiments, the candidate segments may be defined in terms of a hierarchy of rankings. In some embodiments, following the generating, validating, and the aligning of the first, second, and third candidate segments, the computing system may construct a segment according to the rankings of the validated first candidate segments, the validated second candidate segments, and the validated third candidate segments. In some embodiments, the validated second candidate segments are ranked higher than the validated third candidate segments and the validated third candidate segments are ranked higher than the validated first candidate segments. For example, the computing system may construct a segment using validated candidate segments of a highest available ranking. In a particular location or range of locations, if a validated second candidate segment is available, then the computing system may construct a segment using the validated second candidate segment. If a validated second candidate segment is unavailable, then the computing system may construct a segment using a validated third candidate segment. If a validated third candidate segment is unavailable, then the computing system may construct a segment using a validated first candidate segment.

The computing system may construct a portion of the segment using a second candidate segment. When the second candidate segment ends or becomes unavailable, the computing system may extend the second candidate segment using a third candidate segment at a position corresponding to the termination of the second candidate segment. To integrate the third candidate segment with the second candidate segment, the computing system may normalize or conform a lane width of the third candidate segment to a lane width of the second candidate segment consistent. The computing system may further extend the third candidate segment using a first candidate segment. If the third candidate segment is unavailable, the computing system may further extend the second candidate segment using the first candidate segment. In some embodiments, the computing system may correct any lateral offset within the first candidate segment. The lateral offset may arise because the first candidate segment may correspond to any lane within a multi-lane road. If the second candidate segment is discontinuous, the computing system may continue to construct the segment using the second candidate segment if the second candidate segment becomes available.

In this manner, the computing system may generate accurate segments that correspond to lane boundaries, even in situations in which lane markings are unclear or unavailable, and/or if high-definition maps are unavailable. The segments may be augmented or overlaid onto a display or interface. The segments may be used by the computing system, or a different computing system, to compute one or more navigation paths within the boundaries of the segments. The segments and/or the computed one or more navigation paths may be fed to any navigation or actuation system, which controls hardware or drive by wire (DBW) actuators associated with wheels and/or acceleration or braking pedals. The computing system ultimately controls an ego-vehicle to drive or otherwise operate within permitted boundaries as defined by the navigation paths and/or segments. Overall, the computing system elucidates previously unknown or unclear lane boundaries and improves safety for the ego-vehicle, for any safety driver in the ego-vehicle, and for other occupants on the road.

Described herein, in some examples, is a computing system. The computing system includes one or more processors and a memory storing instructions that, when executed by the one or more processors, cause the computing system to perform certain operations. These operations may include obtaining information or data (hereinafter “data”) from one or more sources. The sources may include any of 1) low resolution or standard definition (hereinafter “low resolution”) map data, 2) historical data of an ego-vehicle in which the computing system resides or is otherwise associated, and 3) landmark data. The operations may include generating one or more candidate segments from any of the sources. For example, the candidate segments may include a first candidate segment generated from the low resolution map data, a second candidate segment generated from the historical data of the ego-vehicle, and/or a third candidate segment generated from the landmark data. The operations may include validating the generated one or more candidate segments. The operations may include aligning the validated and generated candidate segments, including any of a first candidate segment, a corresponding second candidate segment, and a corresponding third candidate segment. In some embodiments, the corresponding second candidate segment and the corresponding third candidate segment may correspond to a common region (e.g., a physical location) as the first candidate segment. For example, the second candidate segment and the corresponding third candidate segment may include at least a starting point (e.g., at s=0) corresponding to the first candidate segment.

In some embodiments, the constructed segments may indicate or represent lane boundaries within a road on which the ego-vehicle is currently navigating, and/or within a road in a region where the ego-vehicle is predicted or scheduled to be navigating.

In some embodiments, the operations may further include, filtering out or removing any first candidate segment in which a radius of curvature, occurring anywhere within the first candidate segment, is lower than a first threshold radius of curvature. The first candidate segment may have a nonconstant radius of curvature.

In some embodiments, the operations may further include, defining each of the first candidate segments in terms of a relationship between a longitudinal position and a latitudinal position. The operations may further include, determining any first candidate segment that has a concave down portion and a concave up portion, in which radii of curvature within both the concave down portion and the concave up portion are less than a second threshold radius of curvature. The second threshold radius of curvature may be the same as the first threshold radius of curvature or different from the first threshold radius of curvature. The operations may further include, removing or invalidating the concave down portion and/or the concave up portion.

In some embodiments, the operations may further include, logging, within a log, one or more entries corresponding to historical positions traversed by the ego-vehicle, the historical positions defined according to a latitude and a longitude. The log may include a queue that includes a window. The window may be a fixed duration window, which may preserve only a certain number of historical positions.

In some embodiments, the operations may further include, selectively removing an entry in the log based on a timestamp corresponding to the entry or based on an amount of change in a position compared to a preceding entry. If the change in the position is less than a threshold change, the computing system may remove the entry that corresponds to the position. Thus, the queue may include a double-ended queue that does not simply preserve the most recent points.

In some embodiments, the second candidate segments are generated based on the entries within the log.

In some embodiments, a first candidate segment of the first candidate segments and a second candidate segment of the second candidate segments are validated against each other. The validation may be based on lateral distances between corresponding pairs of points of the first candidate segment and the second candidate segment. The corresponding pairs of points may include a first point of the first candidate segment and a corresponding first point of the second candidate segment, a second point of the first candidate segment and a corresponding second point of the second candidate segment, a third point of the first candidate segment and a corresponding third point of the second candidate segment, a fourth point of the first candidate segment and a corresponding fourth point of the second candidate segment, a fifth point of the first candidate segment and a corresponding fifth point of the second candidate segment, and so on. A distance between the first point of the first segment and the second point of the first segment may be equal to a distance between the first point of the second segment and the second point of the second segment. A distance between the second point of the first segment and the third point of the first segment may be equal to a distance between the second point of the second segment and the third point of the second segment. In other words, a distance between successive points on the first segment may be equal to a distance between corresponding successive points on the second segment.

If a difference between a largest lateral distance and a smallest lateral distance differs by less than a threshold difference, then the computing system may determine that the first candidate segment and the second candidate segment are validated against each other. Otherwise, if the difference between a largest lateral distance and a smallest lateral distance differs by more than a threshold difference, then the computing system may determine a mismatch between the first candidate segment and the second candidate segment, and the first candidate segment may be invalidated.

In some embodiments, a third candidate segment may be validated based on a quality of the third candidate segment. The quality may be determined based on a length, a degree of smoothness, and/or a frequency of oscillations on the third candidate segment.

In some embodiments, the constructing of the segment may include constructing portions of the segment based on a highest ranked validated candidate segment that is available within each of the portions. The highest ranked validated candidate segment may be selected from the validated first candidate segment, the validated second candidate segment, and the validated third candidate segment.

In some embodiments, a validated second candidate segment within or corresponding to a region may be ranked higher than a validated third candidate segment within the region. The validated third candidate segment within the region may be ranked higher than a validated first candidate segment within the region.

In some embodiments, the operations further include computing a navigation path for the ego vehicle based on a restriction of the ego-vehicle operating within boundaries defined by the constructed segment and actuating the ego-vehicle based on the navigation path.

Various embodiments of the present disclosure provide a method implemented by a system as described above.

These and other features of the apparatuses, systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example implementation of a computing system that obtains data from different sources, generates candidate segments that define a lane boundary, and constructs segments from the candidate segments to provide improved navigation of a semi-autonomous vehicle within a lane boundary, in accordance with some embodiments.

FIG. 2 illustrates a block diagram that depicts an example implementation of the computing system, in accordance with some embodiments.

FIGS. 3-5 illustrate example implementations of a computing system that generates and validates candidate segments based on low resolution map data.

FIGS. 6A, 6B, 7A, and 7B illustrate example implementations of a computing system that generates and validates candidate segments based on historical position data of the ego-vehicle history.

FIGS. 8A, 8B, and 8C illustrate example implementations of a computing system that generates and validates candidate segments based on landmarks.

FIG. 9 illustrates example implementations of a computing system that aligns at least a portion of the generated and validated candidate segments.

FIG. 10 illustrates example implementations of a computing system that constructs a segment using the aligned and validated candidate segments.

FIG. 11 illustrates an example implementation of downstream actions or processes.

FIG. 12 illustrates a flowchart which summarizes an exemplary process to generate segments indicative of lane boundaries.

FIG. 13 illustrates a block diagram of a computer system upon which any of the embodiments described herein may be implemented.

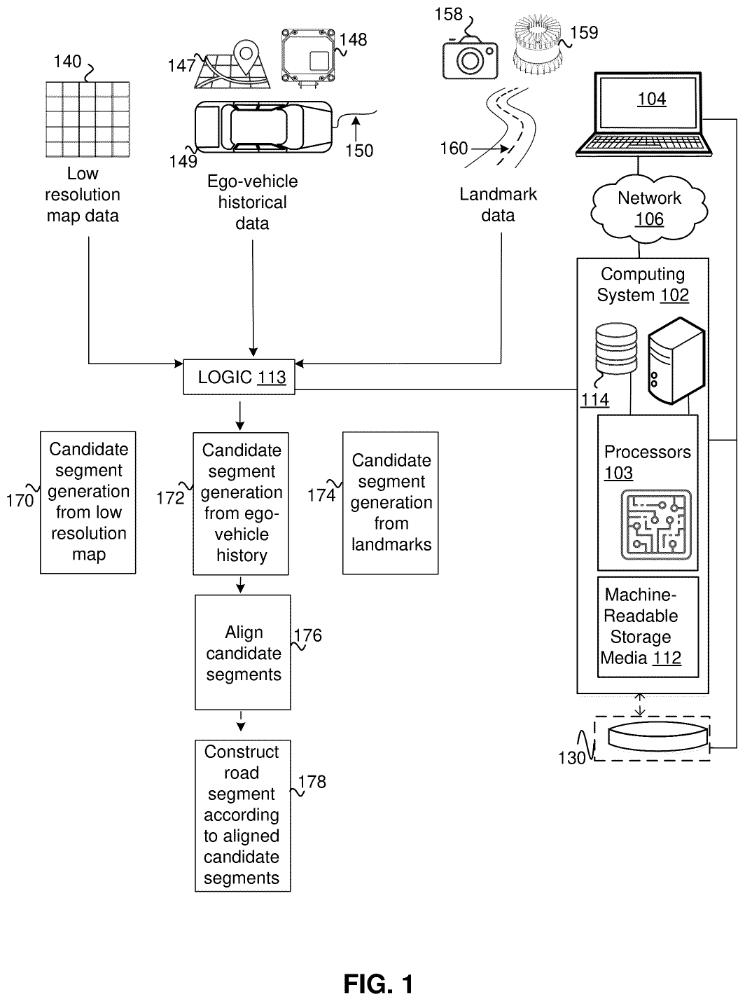

Principles from different figures may apply to, and/or be combined with other figures as suitable. For example, the principles illustrated and described in any of FIGS. 1-5, 6A, 6B, 7A, 7B, 8A, 8B, 8C, and 9-12 may be applied to and/or combined with principles from any of other FIGS.

### DETAILED DESCRIPTION

Safety of vehicles, such as autonomous and semi-autonomous vehicles, remains a paramount concern. Currently, one bottleneck is maintaining a vehicle within a lane, when lane markings are unavailable or unclear, and/or when high-definition map data is unavailable or limited. A computing system addresses this bottleneck by constructing segments that signify lane boundaries or other road demarcations, and computes a navigation path using the segments as a guide in order to maintain a position of an ego-vehicle within the segments.

FIG. 1 illustrates an example implementation of a computing system 102, which may be associated with an ego vehicle, that obtains or derives data from different sources, generates candidate segments that define a lane boundary, and constructs segments from the candidate segments to provide improved navigation of the ego-vehicle within a lane boundary. Relevant principles from FIG. 1 are also applicable to any subsequent FIGS.

The implementation can include at least one computing device 104 which may include or be part of a human-machine interface (HMI) and be operated by an entity such as a user. In some examples, the HMI may be accessible by entities such as a passenger, and/or a remote operator.

In general, the user can interact with the computing device 104 directly or over a network 106, for example, through one or more graphical user interfaces, application programming interfaces (APIs), and/or webhooks, for example, running on the computing device 104. The computing device 104 may include one or more processors and memory. In some examples, the computing device 104 may visually render any results generated, such as the output, the converted output, and/or the data from which the output was generated.

The computing system 102 may include one or more processors 103 which may be configured to perform various operations by interpreting machine-readable instructions, for example, from a machine-readable storage media 112. In some examples, one or more of the processors 103 may be combined or integrated into a single processor, and some or all functions performed by one or more of the processors 103 may not be spatially separated, but instead may be performed by a common processor. The processors 103 may be physical or virtual entities. For example, as physical entities, the processors 103 may include one or more processing circuits, each of which can include one or more processing cores. Additionally or alternatively, for example, as virtual entities, the processors 103 may be encompassed within, or manifested as, a program within a cloud environment. The computing system 102 may also include a storage 114, which may include a cache for faster access compared to a database 130.

The processors 103 may further be connected to, include, or be embedded with logic 113 which, for example, may include, store, and/or encapsulate instructions that are executed to carry out the functions of the processors 103. In general, the logic 113 may be implemented, in whole or in part, as software that is capable of running on the computing system 102, and may be read or executed from the machine-readable storage media 112. The logic 113 may include, as nonlimiting examples, parameters, expressions, functions, arguments, evaluations, conditions, and/or code. Here, in some examples, the logic 113 encompasses functions of or related to obtaining or deriving data from different sources and generating, from the data, one or more candidate segments indicative of lane boundaries.

The database 130 may include, or be capable of obtaining or storing, a subset (e.g., a portion or all) of the data from the different sources, corresponding candidate segments generated, the validated candidate segments and/or aligned candidate segments. For example, the database 130 may store any of the low resolution map data 140, the historical data 150, and/or the landmark data 160. The database 130 may store any intermediate results during the process of generating the outputs.

In FIG. 1, as mentioned, the logic 113 may ingest, obtain, or derive data from different sources, for example, through one or more APIs. This data may include raw and/or processed data, and may be manifested in different formats, including textual data, media data, binary data, unstructured data, and/or structured data. The data may include low resolution map data 140, historical data 150 of an ego-vehicle 149 on which the computing system 102 resides, or which the computing system 102 is otherwise associated with, and landmark data 160. The historical data 150 may be obtained using one or more ego-vehicle sensors such as a GPS 147, an IMU 148, accelerometers, gyroscopes, and magnetometers among other sensors. The landmark data 160 may be obtained using one or more sensors such as a camera 158, a Lidar 159, radar, ultrasonic, sonar, and/or far infrared (FIR) sensors among other sensors. Any of the data may be obtained by combining, merging, fusing, and/or normalizing data from different modalities. Any of the aforementioned sources may be part of the computing system 102, or may be external to the computing system 102.

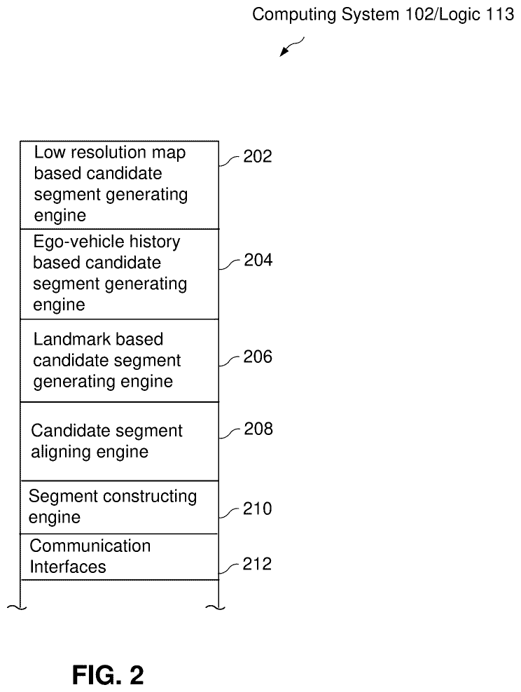

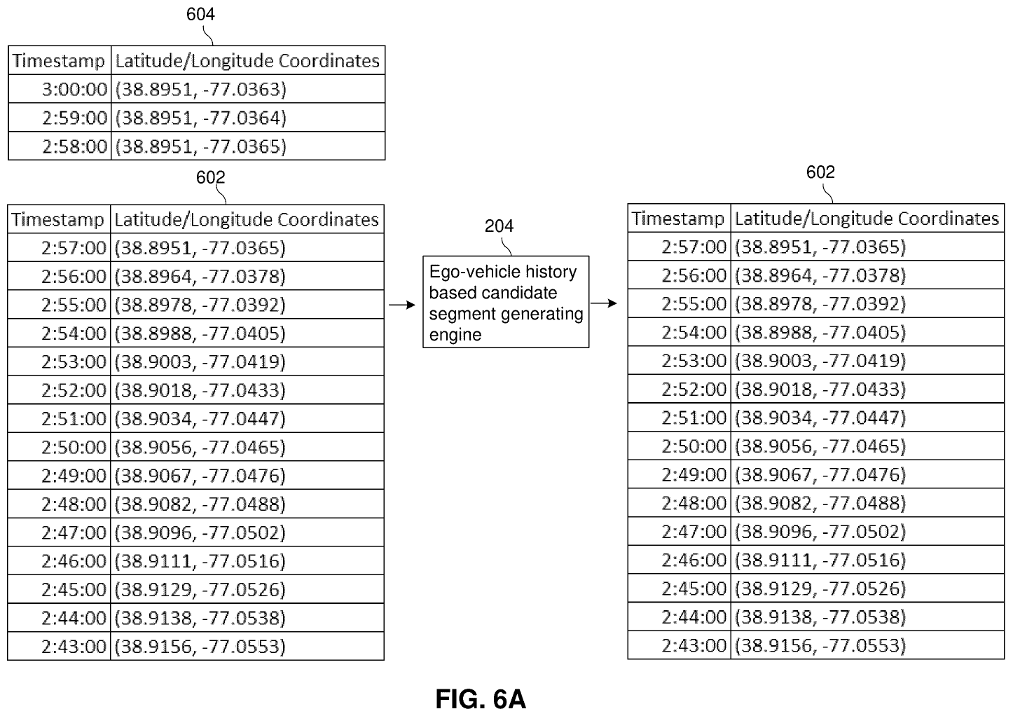

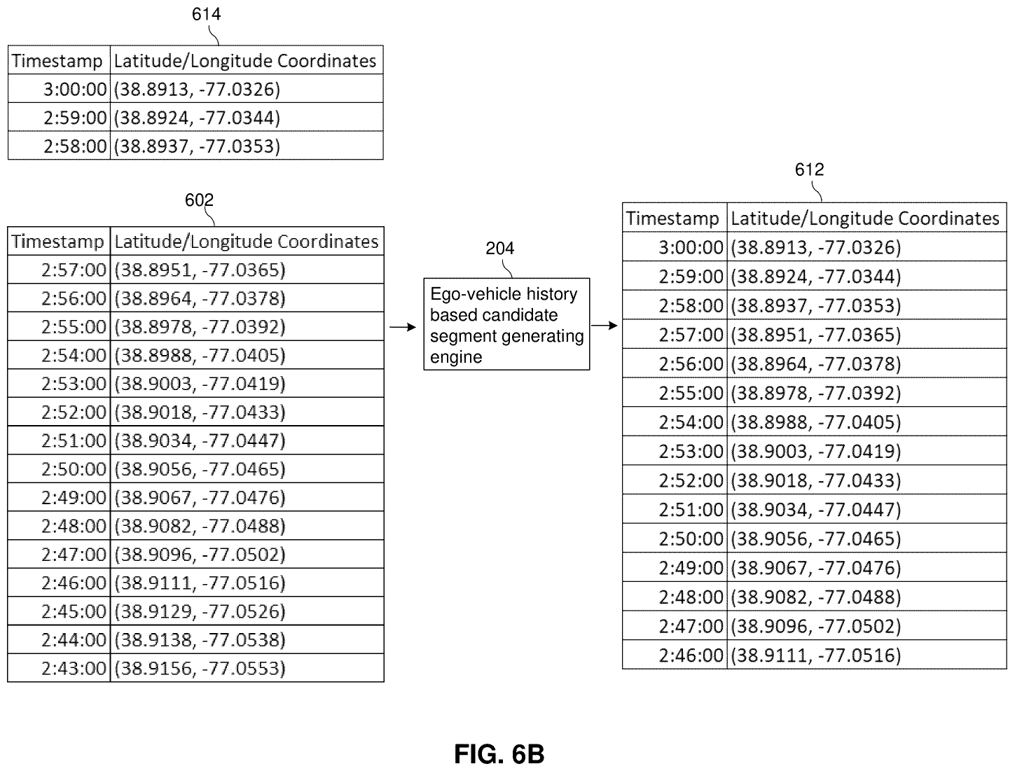

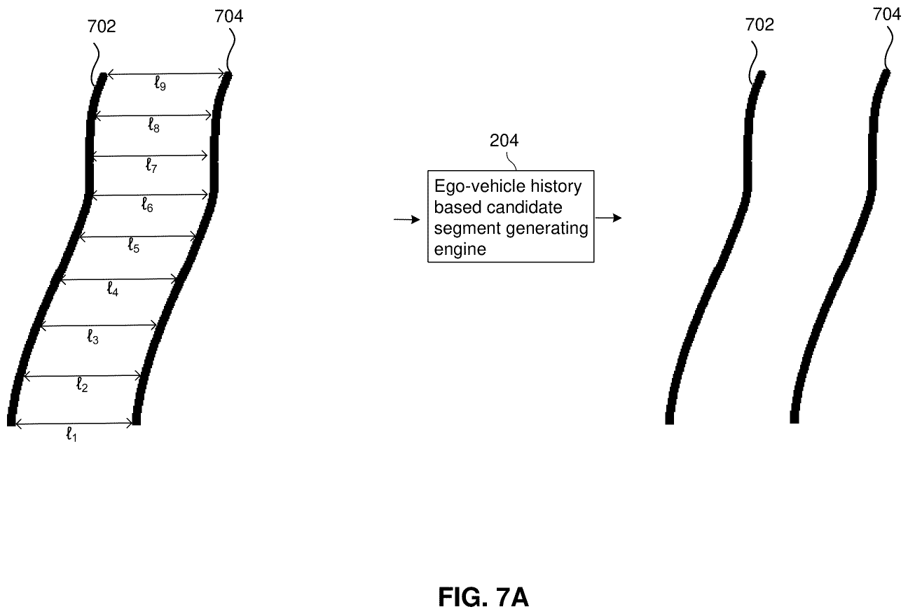

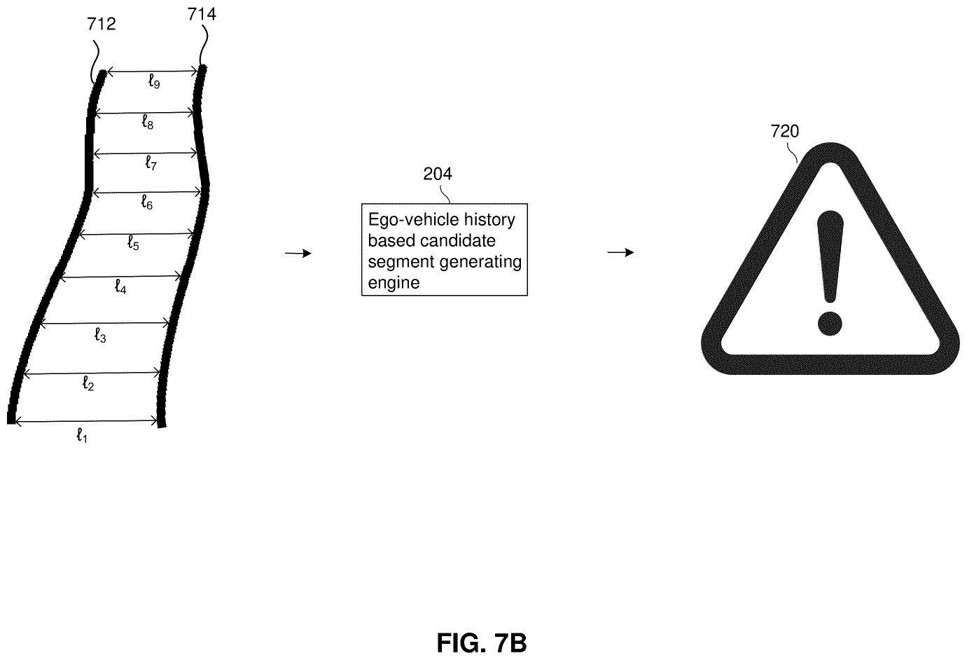

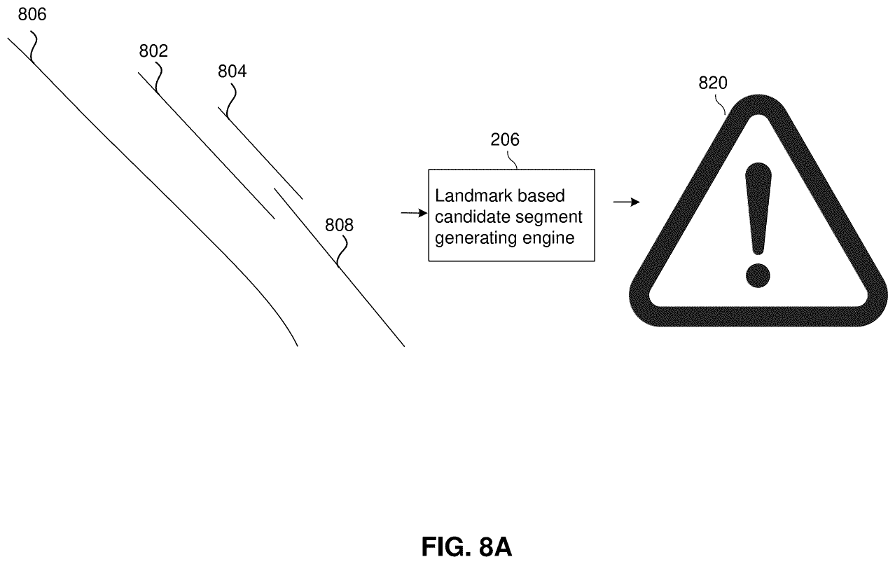

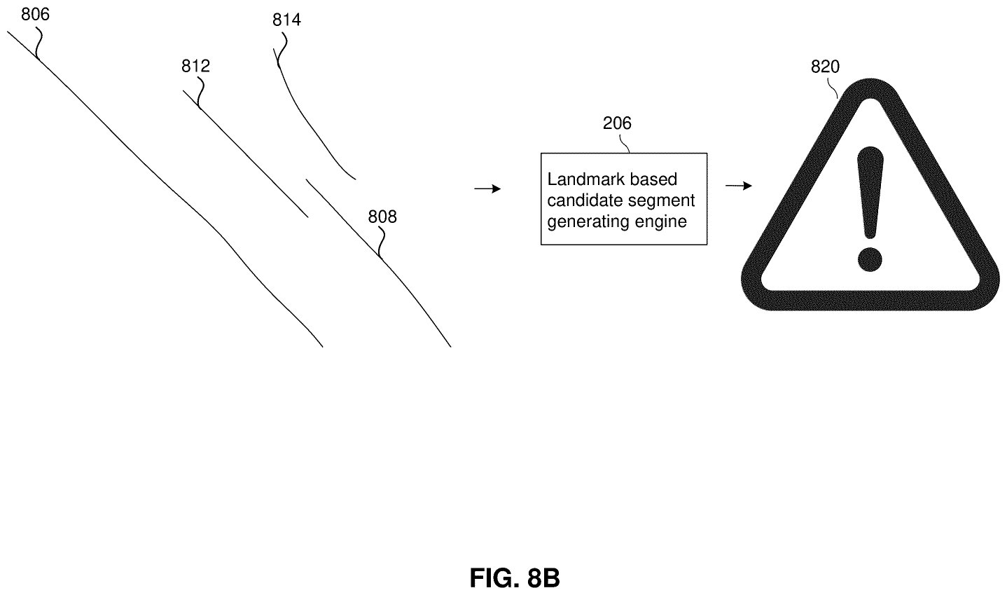

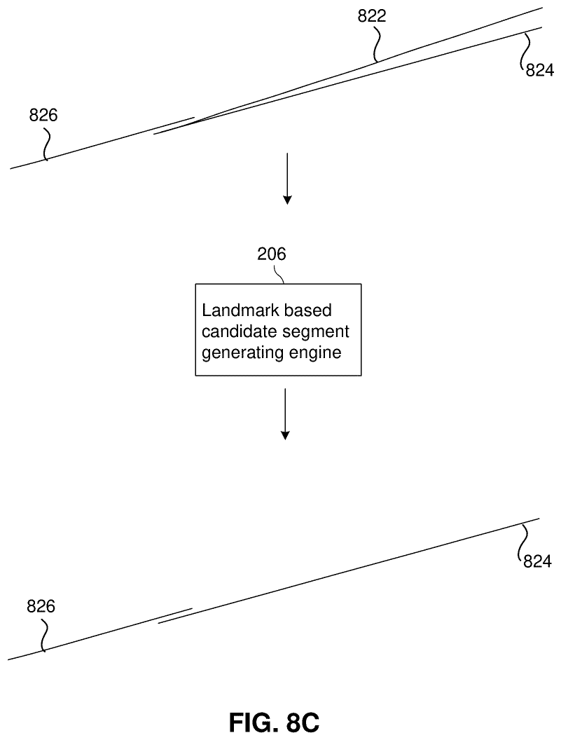

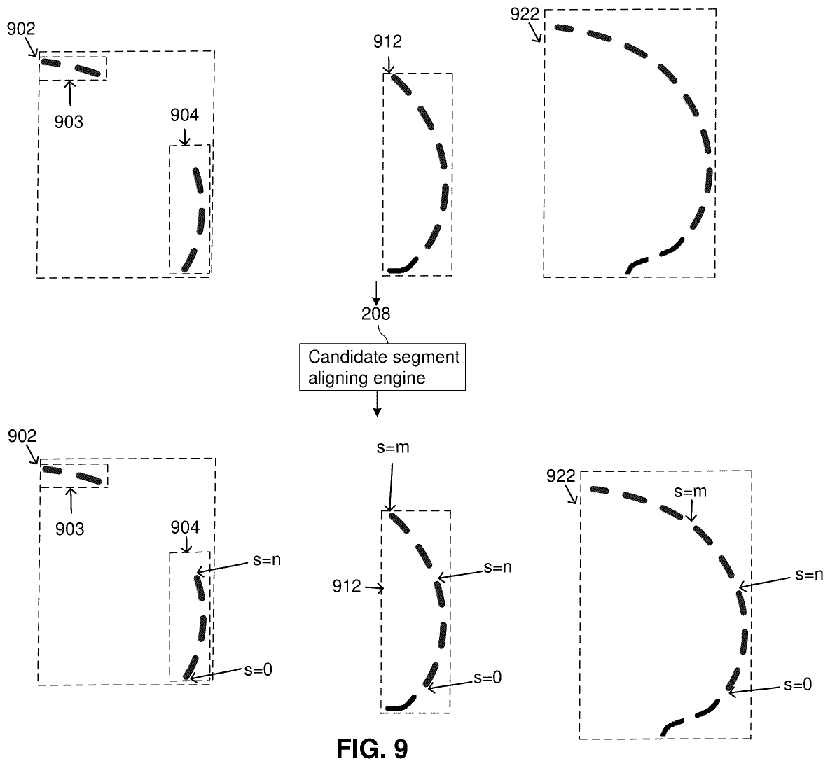

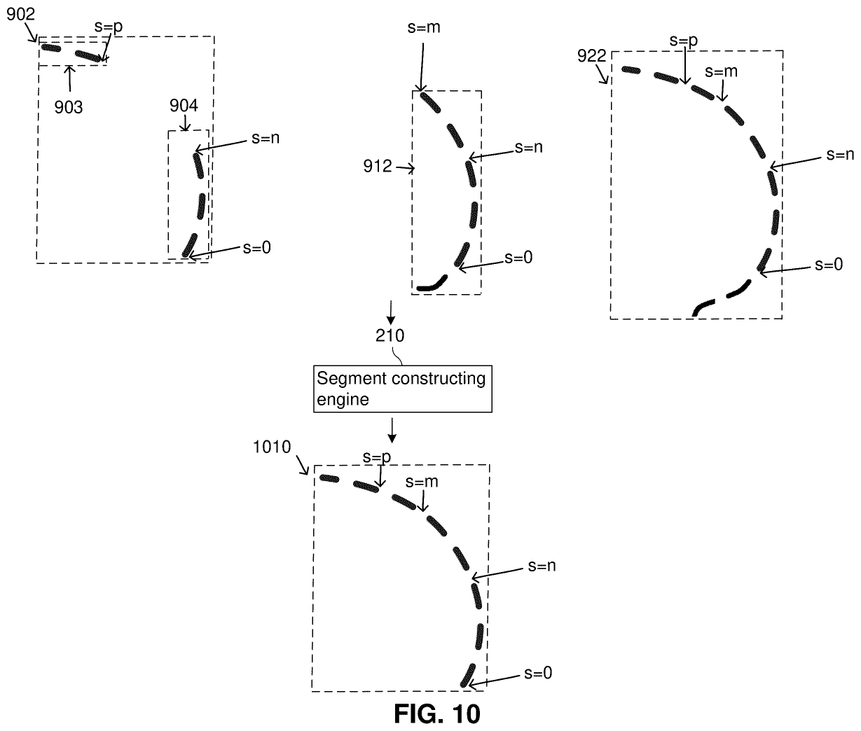

From the obtained data, the logic 113 may generate one or more outputs including one or more candidate segments that indicate potential lane boundaries. The logic 113 may perform entity recognition to decipher and/or interpret the obtained data, for example, based on semantic segmentation and/or instance segmentation. In particular, the logic 113 may perform a process 170 of generating and/or validating a first candidate segment from the low resolution map data 140, as will be further elucidated in FIGS. 2-5. The logic 113 may perform a process 172 of generating and/or validating a second candidate segment from the historical data 150, as will be further elucidated in FIGS. 6A, 6B, 7A, and 7B. The logic 113 may perform a process 174 of generating and/or validating a third candidate segment from the landmark data 160, as will be further elucidated in FIGS. 8A, 8B, and 8C. The logic 113, in a process 176, may align a subset of the generated and validated candidate segments, as will be further elucidated in FIG. 9. The logic may, in a process 178, construct a segment according to the aligned and validated candidate segments, as will be further elucidated in FIG. 10. The logic 113 may provide the segment to any interface or device, such as an HMI device (e.g., the computing device 104 or a portion thereof), and/or to other external entities such as other computing systems or other vehicles. The logic 113, or a different computing system, may compute a navigation path for the ego-vehicle 149 using the segment in order to maintain a position of the ego-vehicle within boundaries defined by the segment. The logic 113, or a different computing system, may perform a navigation and/or an actuation action on the ego-vehicle 149 based on the navigation path.

FIG. 2 illustrates a block diagram that depicts an example implementation of the computing system 102 and/or the logic 113, in accordance with some embodiments. The computing system 102 contains hardware, software and/or firmware capable of communicating with any of the aforementioned sources in FIG. 1 and/or the computing device 104 through APIs, in order to extract the low resolution map data 140, the historical data 150 of the ego-vehicle 149, and the landmark data 160. The computing system 102 includes a low resolution map based candidate segment generating engine 202, an ego-vehicle history based candidate segment generating engine 204, a landmark based candidate segment generating engine 206, a candidate segment aligning engine 208, a segment constructing engine 210, and/or one or more communication interfaces 212.

The low resolution map based candidate segment generating engine 202 is configured to generate and/or validate a first candidate segment, indicative of a potential lane boundary, using the low resolution map data 140, corresponding to the process 170 of FIG. 1. The first candidate segment may be defined or represented according to a set of latitude and longitude coordinates. In some embodiments, each candidate and/or constructed segment may be represented by a parametric curve (x(s), y(s)), where s represents a position or length along the parametric curve. A value of the relative “s” parameter being zero may indicate a current position or a starting position of the ego-vehicle (e.g., the ego-vehicle 149). In some embodiments, the (x(s), y(s)) coordinates may indicate latitude and longitude coordinates, respectively, or be derived from a one-to-one mapping from the latitude and longitude coordinates.

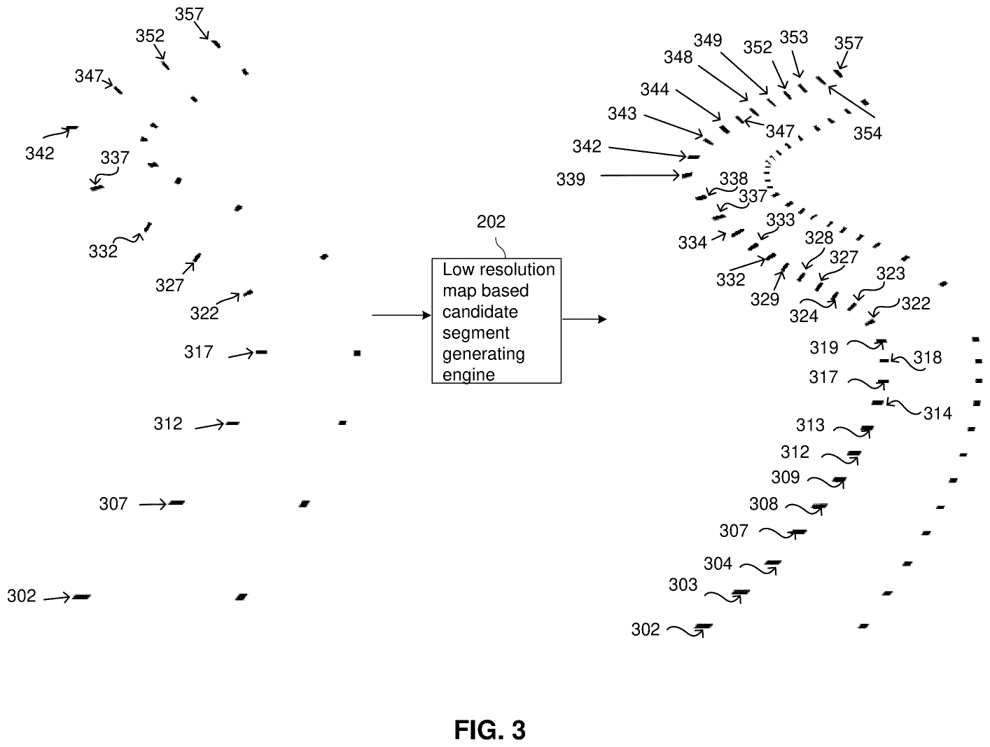

Because raw data from the low-resolution maps may be sparsely populated, the generating of the first candidate segments may include interpolating between points of the raw data to infer additional data points, until a distance between adjacent points is within a threshold distance, as illustrated further in FIG. 3. In some embodiments, the low resolution map based candidate segment generating engine 202 may validate or invalidate the first candidate segment based on a curvature of the first candidate segment. For example, if the curvature exceeds a given threshold (e.g., a first threshold curvature), then the first candidate segment may be invalidated. The curvature exceeding a given threshold may also mean that a radius of curvature is less than a given threshold radius of curvature. The given threshold radius of curvature may be defined based on limitations of actual radii of curvature on actual roads, and/or may be specific to a region. In some embodiments, the given threshold radius of curvature may be defined based on a probability of an actual road having such a threshold radius of curvature. As one nonlimiting example, the given threshold radius of curvature may be defined using a standard of unlikelihood that an actual road would have such a radius of curvature. This standard of unlikelihood may include a 90 percent, 95 percent, 99 percent, 99.9 percent, 99.99 percent, or any relevant percentage of unlikelihood. The curvature may refer to a value of a second derivative ∂²y/∂x² of the longitude in relation to the latitude.

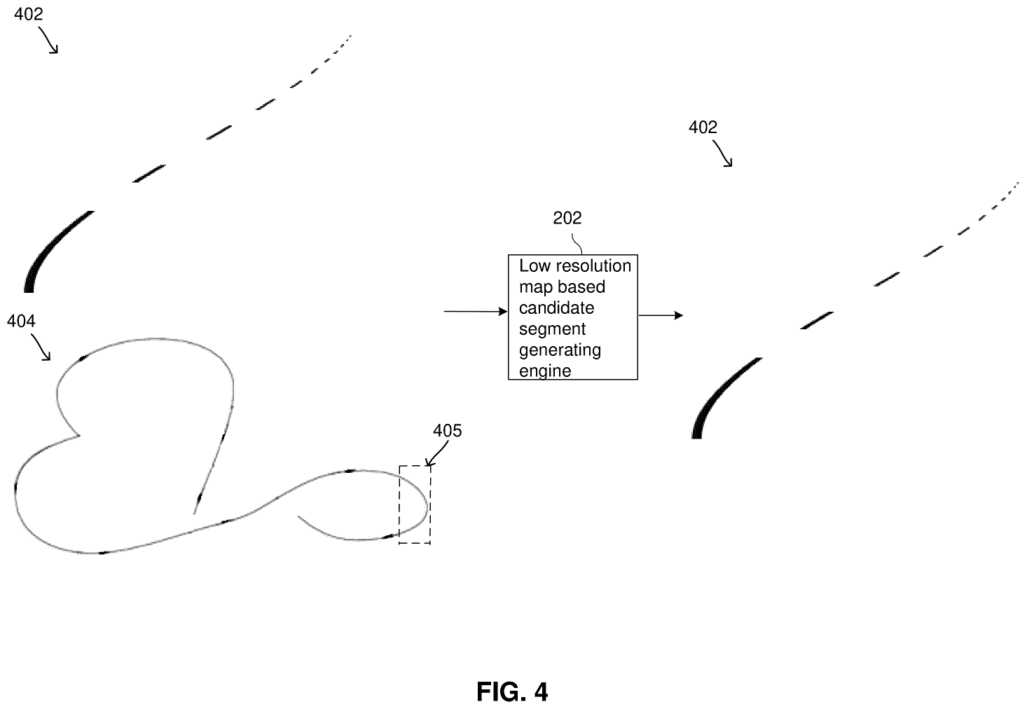

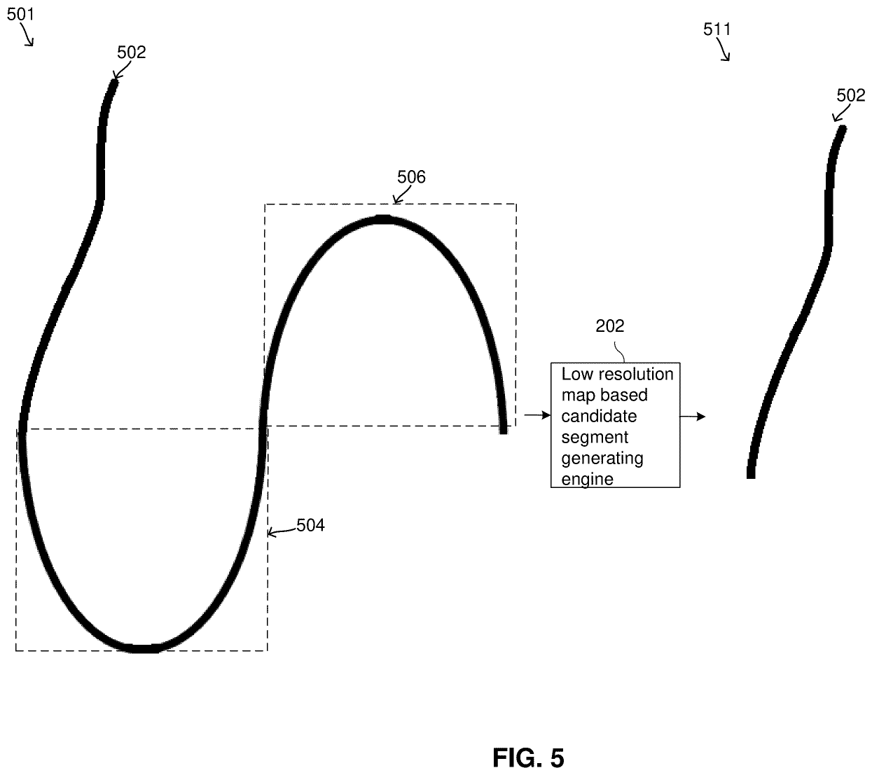

In some embodiments, additionally or alternatively, portions of a first candidate segment that include artifacts such as abrupt changes in curvature, such as zigzags or oscillations, may also be removed or invalidated, as illustrated in FIGS. 4-5. For example, these portions may have a change in curvature from a negative curvature to a positive curvature (e.g., from concave down to concave up), in which the magnitudes or absolute values of the negative curvature and the positive curvature both exceed a given threshold. The given threshold may be equal to the first threshold curvature or may refer to a second threshold curvature. As another example, these portions may have a change in curvature from a positive curvature to a negative curvature (e.g., from concave up to concave down), in which the magnitudes of the positive curvature and the negative curvature both exceed the given threshold. In some examples, these portions also have a rate of change of curvature (e.g., a third derivative ∂³y/∂x³) that exceeds a given threshold rate of change of curvature.

The ego-vehicle history based candidate segment generating engine 204 is configured to generate and/or validate a second candidate segment, indicative of a potential lane boundary, using the historical data 150 of the ego-vehicle 149, corresponding to the process 172 of FIG. 1. The historical data 150 of the ego-vehicle 149 may include historical positions and/or trajectories traversed by the ego-vehicle 149. The historical positions may be logged within a log, as illustrated in FIGS. 6A and 6B. The second candidate segment may be generated based on the log which records the different historical positions. The log may include a limited amount of entries, and data may be selectively retained within the log based on recency of the entries. For example, some older entries may be selectively removed from the log in favor of newer entries. In other examples, some older entries may be selectively retained and newer entries may be selectively removed. For example, if a new entry corresponds to a position that is within a threshold distance of a preceding entry, then the new entry may be removed because it indicates that the ego-vehicle has not moved much over a time period between the preceding entry and the new entry. Thus, the log may selectively record entries in which actual movement occurs, rather than repetitive entries which are not useful for generating second candidate segments.

In some embodiments, the ego-vehicle history based candidate segment generating engine 204 may validate the second candidate segment based on comparison of lateral distances between corresponding points of the second candidate segment and the first candidate segment, as illustrated in FIGS. 7A and 7B. If the lateral distances are consistent between a candidate segment pair (e.g., between a first candidate segment and a corresponding second candidate segment), then the ego-vehicle history based candidate segment generating engine 204 may determine a match between that candidate segment pair. If the lateral distances are inconsistent between the candidate segment pair, then the ego-vehicle history based candidate segment generating engine 204 may determine a mismatch and invalidate the first candidate segment and/or the second candidate segment. For example, if a difference between a maximum lateral distance and a minimum lateral distance exceeds a threshold difference, then the ego-vehicle history based candidate segment generating engine 204 may determine a mismatch and invalidate the first candidate segment and/or the second candidate segment. In other examples, additionally or alternatively, if a standard deviation between the lateral distances exceeds a threshold standard deviation, then the ego-vehicle history based candidate segment generating engine 204 may determine a mismatch and invalidate the first candidate segment and/or the second candidate segment.

The landmark based candidate segment generating engine 206 is configured to generate and/or validate a third candidate segment, indicative of a potential lane boundary, using the landmark data 160, corresponding to the process 174 of FIG. 1 and illustrated in FIGS. 8A-8C. The landmark data may indicate lane boundaries, curbs, or other demarcations captured by one or more sensors such as the camera 158, the Lidar 159, radar, ultrasonic, sonar, and/or far infrared (FIR) sensors among other sensors. The landmark based candidate segment generating engine 206 may validate the third candidate segment by assessing a quality of the third candidate segment. The quality may be determined by a degree of smoothness, consistency, and/or a frequency of oscillations of the third candidate segment. If the third candidate segment exceeds a threshold quality, then the third candidate segment may be validated. In some embodiments, if at least a portion of the third candidate segment has a low quality (e.g., a quality below a threshold quality), then the landmark based candidate segment generating engine 206 may remove those portions or replace that portion with a corresponding portion of the first candidate segment.

The candidate segment aligning engine 208 is configured to align the generated and validated candidate segments, so that a coordinate (x(0), y(0)) of any validated candidate segment refers to the ego-vehicle's current position, corresponding to the process 176 of FIG. 1 and further illustrated in FIG. 9. To align a generated and validated candidate segment, the candidate segment aligning engine 208 may use a first candidate segment as a reference and project either the corresponding second candidate segment or the corresponding third candidate segment onto the first candidate segment. The candidate segment aligning engine 208 may compute a relative distance or offset of the second candidate segment or the third candidate segment and adjust one of the candidate segments to counteract the relative offset.

The segment constructing engine 210 is configured to construct a segment (e.g., an actual segment to be used for navigation) using the aligned and validated candidate segments, corresponding to the process 178 of FIG. 1 and further illustrated in FIG. 10. The segment constructing engine 210 may construct a segment according to the rankings of the validated first candidate segments, the validated second candidate segments, and the validated third candidate segments. In some embodiments, the validated second candidate segments are ranked higher than the validated third candidate segments and the validated third candidate segments are ranked higher than the validated first candidate segments. For example, the segment constructing engine 210 may construct a segment using validated candidate segments of a highest available ranking. In a particular location or range of locations, if a validated second candidate segment is available, then the segment constructing engine 210 may construct a segment using the validated second candidate segment. If a validated second candidate segment is unavailable, then the c segment constructing engine 210 may construct a segment using a validated third candidate segment. If a validated third candidate segment is unavailable, then the segment constructing engine 210 may construct a segment using a validated first candidate segment.

The segment constructing engine 210 may construct a portion of the segment using a second candidate segment. When the second candidate segment ends or becomes unavailable, the segment constructing engine 210 may extend the second candidate segment using a third candidate segment at a position corresponding to the termination of the second candidate segment. To integrate the third candidate segment with the second candidate segment, the segment constructing engine 210 may normalize or conform a lane width of the third candidate segment to a lane width of the second candidate segment consistent. The segment constructing engine 210 may further extend the third candidate segment using a first candidate segment. If the third candidate segment is unavailable, the segment constructing engine 210 may further extend the second candidate segment using the first candidate segment. In some embodiments, the segment constructing engine 210 may correct any lateral offset within the first candidate segment. The lateral offset may arise because the first candidate segment may correspond to any lane within a multi-lane road. If the second candidate segment is discontinuous, the segment constructing engine 210 may continue to construct the segment using the second candidate segment if the second candidate segment becomes available.

The communication interfaces 212 may include APIs and be configured to obtain data from any sources including the low resolution map data 140, the historical data 150, and/or the landmark data 160.

In this manner, the computing system 102 may generate accurate segments that correspond to lane boundaries, even in situations in which lane markings are unclear or unavailable, and/or if high-definition maps are unavailable.

FIG. 3 illustrates an example implementation of the low resolution map based candidate segment generating engine 202. FIG. 3 illustrates interpolation of data acquired from the low resolution map data 140. The low resolution map based candidate segment generating engine 202 may obtain sparsely populated data, from the low resolution map data 140. The low resolution map data 140 may contain points 302, 307, 312, 317, 322, 327, 332, 337, 342, 347, 352, and/or 357, corresponding to different locations, or longitude/latitude positions. The points 302, 307, 312, 317, 322, 327, 332, 337, 342, 347, 352, and/or 357 may correspond to a lane boundary on one side (e.g., a left side). The low resolution map data 140 may also contain points corresponding to a lane boundary on an opposite side (e.g., a right side). In some embodiments, the low resolution map based candidate segment generating engine 202 may generate additional data by interpolating between the existing points 302, 307, 312, 317, 322, 327, 332, 337, 342, 347, 352, and/or 357, until a distance between any two nearest points is less than a threshold distance. For example, the low resolution map based candidate segment generating engine 202 may generate additional data points 303, 304, 308, 309, 313, 314, 318, 319, 323, 324, 328, 329, 333, 334, 338, 339, 343, 344, 348, 349, 353, and/or 354 by interpolating between the existing points 302, 307, 312, 317, 322, 327, 332, 337, 342, 347, 352, and/or 357. The low resolution map based candidate segment generating engine 202 may generate corresponding data points for the lane boundary on an opposite side using the same interpolation process. Interpolating may help resolve the problem of sparsely populated data, and may increase the probability of validating the first candidate segment.

FIG. 4 illustrates an example implementation of the low resolution map based candidate segment generating engine 202, in evaluating first candidate segments based on their curvatures or radii of curvature. FIG. 4 illustrates that segments having large and/or unrealistic curvatures may be invalidated. In particular, the low resolution map based candidate segment generating engine 202 may evaluate first candidate segments 402 and 404. The low resolution map based candidate segment generating engine 202 may determine that a curvature of the first candidate segment 402 is acceptable and does not exceed a first threshold curvature, and/or does not fall below a first threshold radius of curvature. The low resolution map based candidate segment generating engine 202 may determine that the first candidate segment 404 has a curvature (e.g., within a portion 405) that exceeds the first threshold curvature. In some embodiments, the first threshold curvature may be defined based on a likelihood of an actual road having the first threshold curvature and/or frequencies of actual roads that have the first threshold curvature. For example, the first threshold curvature may be defined based on an actual road having some percent unlikelihood, such as a 99 percent unlikelihood, of having a curvature of the first threshold curvature. The low resolution map based candidate segment generating engine 202 may validate the first candidate segment 402, but invalidate the first candidate segment 404.

FIG. 5 illustrates an example implementation of the low resolution map based candidate segment generating engine 202, in evaluating first candidate segments based on their changes in curvature. In particular, FIG. 5 illustrates the invalidating of segments that have sudden changes in curvature. In some examples, for a segment that has any sudden changes in curvature, the sudden changes in curvature may be invalidated. In other examples, for any segment in which a frequency or a rate of sudden changes exceeds a threshold frequency or rate, then the sudden changes may be invalidated. One example of a sudden change in curvature is a change in sign of curvature, from concave up to concave down, or from concave down to concave up, in which both the magnitude of the concave up curvature and the concave down curvature exceed some given threshold. In particular, the low resolution map based candidate segment generating engine 202 may evaluate a candidate segment 501 having a first portion 502, a second portion 504, and a third portion 506. The low resolution map based candidate segment generating engine 202 may determine that the second portion 504 is concave up (e.g., convex downwards), while the third portion 506 is concave down (e.g., convex upwards). If the low resolution map based candidate segment generating engine 202 determines that the magnitudes or absolute values of curvatures within the second portion 504 and the third portion 506 also exceed some given magnitude (e.g., a second threshold curvature), then the low resolution map based candidate segment generating engine 202 may invalidate the second portion 504 and/or the third portion 506. Here, assuming that the low resolution map based candidate segment generating engine 202 determines that the magnitudes of curvatures within the second portion 504 and the third portion 506 exceed some given magnitude, the low resolution map based candidate segment generating engine 202 may invalidate either both the second portion 504 and the third portion 506, or one of the second portion 504 and the third portion 506. In some embodiments, the low resolution map based candidate segment generating engine 202 may additionally determine that a rate of change of the curvature (e.g., a third derivative ∂³y/∂x³) also has to exceed a given threshold rate of change of curvature in order to invalidate the second portion 504 and/or the third portion 506. In some embodiments, the low resolution map based candidate segment generating engine 202 may invalidate the second portion 504 and/or the third portion 506 based on a rate of change of the curvature within the second portion 504 and/or the third portion 506 exceeding a threshold rate of change. In some embodiments, the low resolution map based candidate segment generating engine 202 may invalidate the second portion 504 and/or the third portion 506 based on a combination of the aforementioned criteria regarding a change in curvature, and based on a rate of change of the curvature exceeding a threshold rate of change. The low resolution map based candidate segment generating engine 202 may iteratively evaluate the candidate segment 501 to validate or invalidate portions of the candidate segment 501, using a given step size as an iteration.

The low resolution map based candidate segment generating engine 202 may modify the candidate segment 501 into a modified candidate segment 511, which removes any invalidated portions. The modified candidate segment 511 may be validated. FIG. 6A illustrates an example implementation of the ego-vehicle history based candidate segment generating engine 204 in updating a log that records historical positions of the ego-vehicle 149. The ego-vehicle history based candidate segment generating engine 204 may obtain the historical data 150 and normalize or organize the historical data 150 into a standardized format such as a log. The ego-vehicle history based candidate segment generating engine 204 may update the log with new entries depending on relative position changes of the new entries with respect to one or more previous positions. In FIG. 6A, the ego-vehicle history based candidate segment generating engine 204 may generate a log 602 that includes historical positions of the ego-vehicle 149 at respective timestamps. The ego-vehicle history based candidate segment generating engine 204 may obtain new data 604 containing new or updated positions at new timestamps. Because an amount of data, and/or a number of entries, permitted to be stored in a log may be limited, when the new data 604 arrives, the ego-vehicle history based candidate segment generating engine 204 may need to determine whether or not to discard older data such as previous entries within the log 602. In some embodiments, if the new data 604 includes entries showing that a position has changed, compared to previous positions, by more than a threshold longitude and/or latitude distance, then the ego-vehicle history based candidate segment generating engine 204 may determine to discard or evict older data entries. However, if the new data 604 shows that the position of the ego-vehicle 149 has not changed, compared to previous positions, by more than a threshold longitude and/or latitude distance, then the ego-vehicle history based candidate segment generating engine 204 may determine to discard the new data 604 and retain the older data entries. In this process, because data of same positions is not helpful in generating a candidate segment, the ego-vehicle history based candidate segment generating engine 204 may retain log data that is most useful in generating a candidate segment.

In FIG. 6A, the ego-vehicle history based candidate segment generating engine 204 may determine that the new data 604 does not contain any new positions relative to already existing positions within the log 602 (e.g., compared to the timestamp 2:57:00). Therefore, the ego-vehicle history based candidate segment generating engine 204 may determine to discard the new data 604. Here, discarding or evicting may refer to removal of data from the log 602 but still maintaining the data somewhere in storage (e.g., within the datastores 130) at least for some period of time, in an event the removed data needs to be restored.

FIG. 6B illustrates an example implementation of the ego-vehicle history based candidate segment generating engine 204. In FIG. 6B, the ego-vehicle history based candidate segment generating engine 204 may generate the log 602 that includes historical positions of the ego-vehicle 149 at respective timestamps. The ego-vehicle history based candidate segment generating engine 204 may obtain new data 614 containing new or updated positions at new timestamps. The ego-vehicle history based candidate segment generating engine 204 may determine that the new data 614 includes sufficient position changes with respect to the previous entries within the log 602 (e.g., compared to latitude/longitude coordinates at the timestamp 2:57:00). The ego-vehicle history based candidate segment generating engine 204 may determine to append the new data 614 into the log 602, while discarding oldest entries (e.g., corresponding to timestamps 2:43:00, 2:44:00, and 2:45:00) within the log 602. The ego-vehicle history based candidate segment generating engine 204 may generate an updated log 612 that includes the new data 214 and discards the oldest entries. The logs 602 and/or 612, as illustrated in FIGS. 6A and 6B, may be used to generate one or more second candidate segments. In some embodiments, additionally or alternatively, historical data may be obtained from one or more other vehicles besides the ego-vehicle 149, and may be used to generate logs and/or a second candidate segment.

FIG. 7A illustrates an example implementation of the ego-vehicle history based candidate segment generating engine 204. In FIG. 7A, the ego-vehicle history based candidate segment generating engine 204 validates or invalidates a second candidate segment by comparing corresponding lateral distances between the second candidate segment and a first candidate segment. If the corresponding lateral distances have a high degree of consistency or uniformity across the second candidate segment and a first candidate segment, then the ego-vehicle history based candidate segment generating engine 204 may determine that the second candidate segment and the first candidate segment match. However, if the corresponding lateral distances have a high degree of inconsistency or lack uniformity, then the ego-vehicle history based candidate segment generating engine 204 may determine that the second candidate segment and the first candidate segment mismatch. Upon determining a mismatch, the ego-vehicle history based candidate segment generating engine 204 may invalidate the second candidate segment and/or the first candidate segment.

In FIG. 7A, the ego-vehicle history based candidate segment generating engine 204 may determine lateral distances [symbol] ₁, [symbol] ₂, [symbol] ₃, [symbol] ₄, [symbol] ₅, [symbol] ₆, [symbol] ₇, [symbol] ₈, [symbol] ₉, between corresponding positions of a first candidate segment 702 and a second candidate segment 704. It is contemplated that the ego-vehicle history based candidate segment generating engine 204 may determine lateral distances between any number of corresponding positions. The ego-vehicle history based candidate segment generating engine 204 may determine that the lateral distances are largely uniform (e.g., having a small standard deviation that satisfies a permitted threshold standard deviation). Additionally or alternatively, the ego-vehicle history based candidate segment generating engine 204 may determine that a maximum lateral distance and a minimum lateral distance do not differ by more than a threshold lateral distance. Therefore, the—vehicle history based candidate segment generating engine 204 may determine a match between the first candidate segment 702 and the second candidate segment 704, and may thus validate the second candidate segment 704 and/or the first candidate segment 702.

In FIG. 7B, the ego-vehicle history based candidate segment generating engine 204 may determine lateral distances [symbol] ₁, [symbol] ₂, [symbol] ₃, [symbol] ₄, [symbol] ₅, [symbol] ₆, [symbol] ₇, [symbol] ₈, [symbol] ₉, between corresponding positions of a first candidate segment 712 and a second candidate segment 714. In FIG. 7B, unlike in FIG. 7A, the ego-vehicle history based candidate segment generating engine 204 may determine a lack of uniformity of the lateral distances [symbol] ₁, [symbol] ₂, [symbol] ₃, [symbol] ₄, [symbol] ₅, [symbol] ₆, [symbol] ₇, [symbol] ₈, [symbol] ₉. Additionally or alternatively, the ego-vehicle history based candidate segment generating engine 204 may determine that a difference between a maximum lateral distance (e.g., [symbol] ₁) and a minimum lateral distance (e.g., [symbol] ₉) exceeds a threshold permitted difference. Thus, the ego-vehicle history based candidate segment generating engine 204 may output an alert 720 or some other indication that indicates a mismatch, and/or may invalidate one or both of the second candidate segment 714 and the first candidate segment 712.

FIG. 8A illustrates an example implementation of the landmark based candidate segment generating engine 206. In FIG. 8A, the landmark based candidate segment generating engine 206 evaluates one or more third candidate segments. The landmark based candidate segment generating engine 206 may obtain third candidate segments 802 and 804, which may correspond to opposite boundaries (e.g., a left and right boundary of a lane). FIG. 8A also shows a first candidate segment 806 and a second candidate segment 808. The landmark based candidate segment generating engine 206 may evaluate the third candidate segments 802 and 804 based on various criteria, including length, degree of smoothness, and a level of consistency between the third candidate segments 802 and 804. Here, the landmark based candidate segment generating engine 206 may determine that the third candidate segments 802 and 804 are too short and output an alert 820 or some other indication that the third candidate segments 802 and 804 are invalidated.

FIG. 8B illustrates an example implementation of the landmark based candidate segment generating engine 206. In FIG. 8B, the landmark based candidate segment generating engine 206 evaluates one or more third candidate segments. The landmark based candidate segment generating engine 206 may obtain third candidate segments 812 and 814, which may correspond to opposite boundaries (e.g., a left and right boundary of a lane). The landmark based candidate segment generating engine 206 may invalidate the third candidate segments 812 and 814 because the third candidate segments 812 and 814 diverge from each other, as lateral distances between the third candidate segments 812 and 814 are nonuniform. Thus, the landmark based candidate segment generating engine 206 may generate the alert 820 or other indication that the third candidate segments 812 and 814 are invalidated.

FIG. 8C illustrates an example implementation of the landmark based candidate segment generating engine 206 validating a third candidate segment 824. FIG. 8C also illustrates a first candidate segment 822 and a second candidate segment 826. Although in FIG. 8C, only a single third candidate segment 824 is shown (e.g., corresponding to either a left or a right boundary), it is contemplated that the third candidate segment 824 may include both left and right boundaries. In FIG. 8C, the landmark based candidate segment generating engine 206 determines that the third candidate segment 824 is sufficiently long and smooth. Therefore, the landmark based candidate segment generating engine 206 may validate the third candidate segment 824. Upon validating the third candidate segment 824, the landmark based candidate segment generating engine 206 may remove a corresponding first candidate segment 822, even if the first candidate segment 822 is smooth.

FIG. 9 illustrates an example implementation of the candidate segment aligning engine 208, to align a validated first candidate segment 922, a validated second candidate segment 902, and a validated third candidate segment 912. The aligning process may result in correlating points in any of the validated first candidate segment 922, the validated second candidate segment 902, and the validated third candidate segment 912. After aligning, a coordinate (x(0), y(0)) of any validated candidate segment refers to the ego-vehicle's current position. To align a generated and validated candidate segment, the candidate segment aligning engine 208 may use a particular validated candidate segment (e.g., the validated first candidate segment) as a reference and project any of the other validated candidate segments (e.g., either the corresponding validated second candidate segment or the corresponding validated third candidate segment) onto the reference (e.g., the validated first candidate segment). The computing system may compute a relative distance or offset (e.g., a relative “s” parameter) of the validated second candidate segment or the validated third candidate segment. The computing system may adjust or shift one of the validated candidate segments to counteract the relative offset by subtracting the determined relative “s” parameter of one of the validated candidate segments.

In some embodiments, the validated first candidate segment 922 may be shifted with respect to the validated second candidate segment 902 to align the validated first candidate segment 922 to the validated second candidate segment 902. Next, the validated third candidate segment 912 may be shifted with respect to the shifted first candidate segment to also align the third candidate segment 912.

In FIG. 9, the validated second candidate segment 902 may include portions 903 and 904. In other embodiments, the portions 903 and 904 may be part of different validated candidate segments. The candidate segment aligning engine 208 may, following the aligning, establish the s=0 positions of each of the validated second candidate segment 902, the validated third candidate segment 912, and the validated first candidate segment 922. Thus, positions on each of the validated second candidate segment 902, the validated third candidate segment 912, and the validated first candidate segment 922 may be correlated to one another, even if, for example, some of the candidate segments 902, 912, and/or 922 start at a different position. As previously alluded to, a relative “s” parameter may indicate a current position and/or a planned navigation position of the ego-vehicle 149. Here, positions corresponding to s=n, s=m, and s=p, where n, m, and p are different numbers, may also be correlated on each of the validated second candidate segment 902, the validated third candidate segment 912, and the validated first candidate segment 922. Aligning the validated second candidate segment 902, the validated third candidate segment 912, and the validated first candidate segment 922 facilitates the constructing of the segment, as illustrated in FIG. 10, using portions of any of the validated second candidate segment 902, the validated third candidate segment 912, and the validated first candidate segment 922.

FIG. 10 illustrates an example implementation of the segment constructing engine 210 in constructing a segment 1010 using portions of the validated second candidate segment 902, the validated third candidate segment 912, and the validated first candidate segment 922, following alignment in FIG. 9. For example, the segment constructing engine 210 may construct a segment using validated candidate segments of a highest available ranking. If a validated second candidate segment is available within one portion, then the segment constructing engine 210 may construct a segment using the validated second candidate segment in that portion. If a validated second candidate segment is unavailable in that portion, then the computing system may construct a segment using a validated third candidate segment in that portion. If a validated third candidate segment is unavailable in that portion, then the computing system may construct a segment using a validated first candidate segment in that portion.

Here, the segment constructing engine 210 may construct the segment 1010 using the validated second candidate segment 902 in a portion from s=0 to s=n. At s=n, a validated second candidate segment becomes unavailable (e.g., no validated historical ego-vehicle data exists), so the segment constructing engine 210 may construct a portion from s=n to s=m using the validated third candidate segment 912. At s=m, a validated third candidate segment becomes unavailable (e.g., no validated landmark data exists) so the segment constructing engine 210 may construct a portion from s=m to s=p using the validated first candidate segment 922. At s=p, a validated second candidate segment 902 (e.g., the portion 903) becomes available again, so the segment constructing engine 210 may construct a portion starting from s=p using the validated second candidate segment 902.

In some embodiments, from s=n to s=m, the segment constructing engine 210 may match a lane width of the portion from s=0 to s=n if both left and right landmarks are available. In some embodiments, if only 1 landmark is available, the lane width is set to max(constant_minimum_lane_width, 2*(ego_car_distance_to_the_single_lane_boundary)) so that the transition at s=n is smooth.

In some embodiments, from s=m to s=p, the segment constructing engine 210 may adjust for a random lateral offset. The random lateral offset may be adjusted using the last position of the ego vehicle 149. This last position may be determined by a latest point in the validated third candidate segment 912 before the transition to the validated first candidate segment 922 if the third candidate segment exists (e.g., is nonempty). If the validated third candidate segment is empty, then the last position may be determined using the latest point in the validated second candidate segment 902 before the transition to the validated first candidate segment 922.

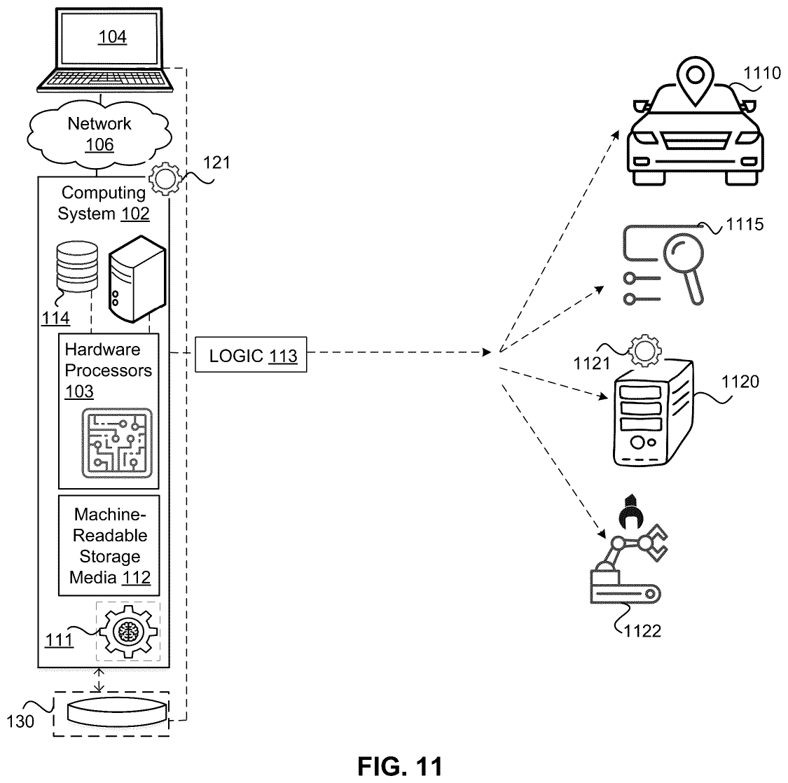

FIG. 11 illustrates downstream actions, as part of a workflow or a process, which may occur concurrent with, or following the constructing of the segments as illustrated in the previous FIGS. The computing system 102 and/or a different computing system may implement a navigation or locomotive (e.g., actuation) action based on the constructed segments.

Specifically, downstream actions may encompass performing navigation 1110, additional monitoring 1115, transmitting and/or writing information to a different computing system 1120, for example, via an API 1121, and/or maintenance or other physical operations 1122 such as adjusting a physical or electronic infrastructure or components of a vehicle (e.g., the ego-vehicle 149) in order to better react to certain safety conditions.

As an example of the additional monitoring 1115, the computing system 102 and/or a different computing system may monitor statistics and vehicle parameters such as engine operation parameters (e.g., engine rotation rate), moment of inertia, and/or position of center of gravity, to ensure safe operation of a vehicle, in particular, to verify whether attributes or parameters of a vehicle fall within certain operating ranges or thresholds. In some examples, the additional monitoring 1115 may occur in response to certain attributes or parameters falling outside of certain operating ranges or thresholds. This monitoring or recording of other entity types may be performed by the computing system 102, or may be delegated to a different processor. In other examples, a downstream action may include the writing of information. Such writing of information may encompass transmission or presentation of information, an alert, and/or a notification to the computing device 104 and/or to other devices. The information may include indications of which attributes or parameters of a vehicle may fall outside of operating ranges or thresholds, or reasons that an alert was triggered, and/or one or more timestamps corresponding to an originating or creation time of underlying data that caused the triggering of the alert. Alternatively, an alert may be triggered using a predicted time at which an attribute or parameter may be predicted to fall outside of an operating range or threshold.

In other examples, a downstream action may entail an applications programming interface (API) of the computing system 102 interfacing with or calling the API 1121 of the different computing system 1120. For example, the different computing system 1120 may perform analysis and/or transformation or modification of data, through some electronic or physical operation. Meanwhile, the physical operations 1122 may include controlling braking, steering, and/or throttle components to effectuate a throttle response, a braking action, and/or a steering action during navigation.

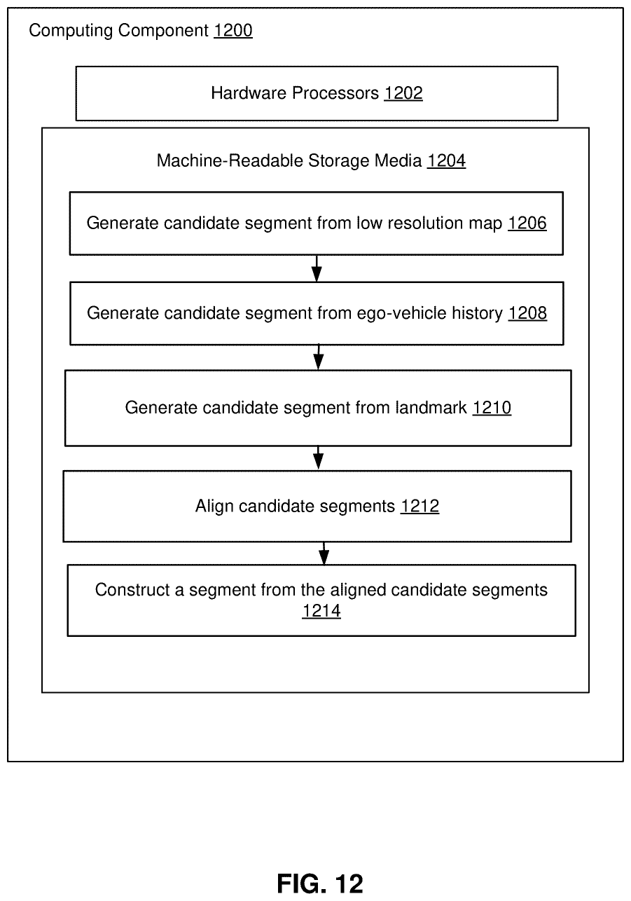

FIG. 12 illustrates a computing component 1200 that includes one or more hardware or other processors 1202 and machine-readable storage media 1204 storing a set of machine-readable/machine-executable instructions that, when executed, cause the processor(s) 1202 to perform an illustrative method of generating an output and converting the generated output into a converted output. The computing component 1200 may be implemented as the computing system 102 of FIG. 1. The processors 1202 may be implemented as the processors 103. The machine-readable storage media 1204 may be implemented as the machine-readable storage media 112, and may include suitable machine-readable storage media.

At step 1206, the processors 1202 may execute machine-readable/machine-executable instructions stored in the machine-readable storage media 1204 to generate and/or validate a first candidate segment, indicative of a potential lane boundary, from low resolution map data (e.g., the low resolution map data 140 of FIG. 1).

At step 1208, the processors 1202 may execute machine-readable/machine-executable instructions stored in the machine-readable storage media 1204 to generate and/or validate a second candidate segment from historical data (e.g., the historical data 150 of FIG. 1) of the ego-vehicle (e.g., the ego-vehicle 149 of FIG. 1).

At step 1210, the processors 1202 may execute machine-readable/machine-executable instructions stored in the machine-readable storage media 1204 to generate and/or validate a third candidate segment from landmark data (e.g., the landmark data 160 of FIG. 1).

At step 1212, the processors 1202 may execute machine-readable/machine-executable instructions stored in the machine-readable storage media 1204 to align the validated first, second, and third candidate segments, in order to correlate same locations corresponding to each of the validated first, second, and third candidate segments.

At step 1214, the processors 1202 may execute machine-readable/machine-executable instructions stored in the machine-readable storage media 1204 to construct one or more segments from the aligned and validated candidate segments.

The techniques described herein, for example, are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination.

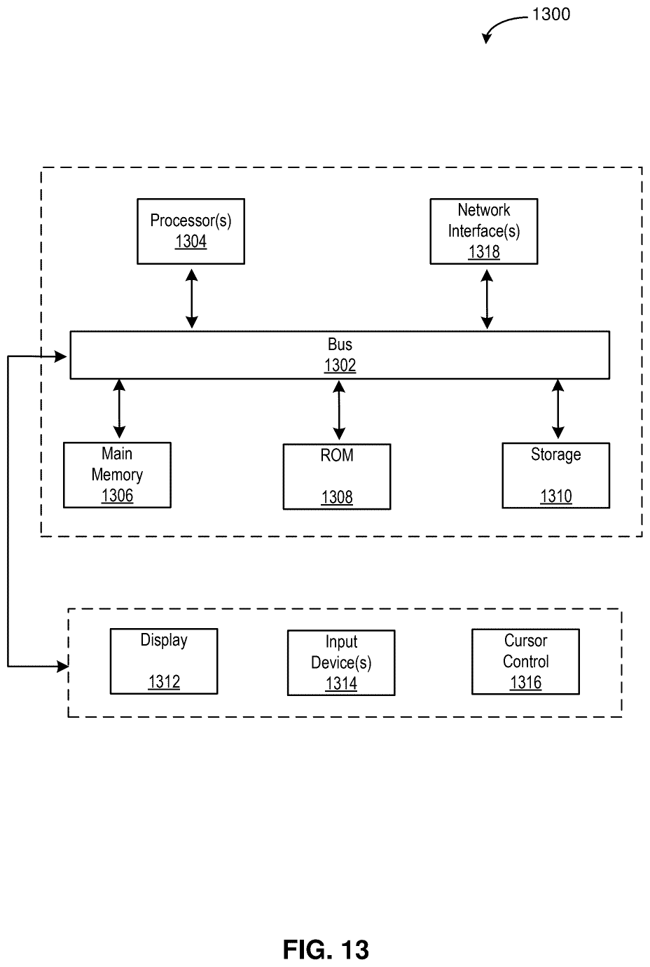

FIG. 13 illustrates a block diagram of a computer system 1300 upon which any of the embodiments described herein may be implemented. The computer system 1300 includes a bus 1302 or other communication mechanism for communicating information, one or more hardware or other processors, such as cloud processors, 1304 coupled with bus 1302 for processing information. A description that a device performs a task is intended to mean that one or more of the processor(s) 1304 performs.

The computer system 1300 also includes a main memory 1306, such as a random access memory (RAM), cache and/or other dynamic storage devices, coupled to bus 1302 for storing information and instructions to be executed by processor 1304. Main memory 1306 also may be used for storing temporary variables or other intermediate information during execution of instructions to be executed by processor 1304. Such instructions, when stored in storage media accessible to processor 1304, render computer system 1300 into a special-purpose machine that is customized to perform the operations specified in the instructions.

The computer system 1300 further includes a read only memory (ROM) 1308 or other static storage device coupled to bus 1302 for storing static information and instructions for processor 1304. A storage device 1310, such as a magnetic disk, optical disk, or USB thumb drive (Flash drive), etc., is provided and coupled to bus 1302 for storing information and instructions.

The computer system 1300 may be coupled via bus 1302 to output device(s) 1312, such as a cathode ray tube (CRT) or LCD display (or touch screen), for displaying information to a computer user. Input device(s) 1314, including alphanumeric and other keys, are coupled to bus 1302 for communicating information and command selections to processor 1304. Another type of user input device is cursor control 1316. The computer system 1300 also includes a communication interface 1318 coupled to bus 1302.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiment.

A component being implemented as another component may be construed as the component being operated in a same or similar manner as the another component, and/or comprising same or similar features, characteristics, and parameters as the another component.

1. A system comprising:
one or more processors; and
a memory storing instructions that, when executed by the one or more processors, cause the system to perform:
obtaining data from a plurality of sources, wherein the plurality of sources comprise any of low resolution map data, historical data of an ego-vehicle position, and landmark data;
generating one or more candidate segments indicative of potential lane boundaries, the candidate segments comprising any of a first candidate segment generated from the low resolution map data, a second candidate segment generated from the historical data of the ego-vehicle position, and a third candidate segment generated from the landmark data;
validating the generated one or more candidate segments;
aligning the validated and generated one or more candidate segments;
constructing a segment based on the aligned, validated, and generated one or more candidate segments, the segment defining a lane boundary, wherein the segment is used to compute a navigation path for the ego-vehicle to operate the ego-vehicle within the lane boundary defined by the segment.

2. The system of claim 1, wherein the validating of the generated one or more candidate segments comprises filtering out or removing any first candidate segment in which a radius of curvature, occurring anywhere within the first candidate segment, is lower than a first threshold radius of curvature.

3. The system of claim 1, wherein the generating of the one or more candidate segments comprises defining the generated one or more candidate segments in terms of a relationship between a longitudinal position and a latitudinal position.

4. The system of claim 1, wherein the validating of the generated one or more candidate segments comprises determining any first candidate segment that has a concave down portion and a concave up portion, in which radii of curvature within both the concave down portion and the concave up portion are less than a second threshold radius of curvature; and filtering out or removing the concave down portion and the concave up portion.

5. The system of claim 2, wherein the generating of the one or more candidate segments comprises:
logging, within a log, one or more entries corresponding to historical positions traversed by the ego-vehicle, the historical positions defined according to a latitude and a longitude; and
generating the second candidate segment based on the logged one or more entries.

6. The system of claim 5, wherein the generating of the one or more candidate segment further comprises selectively removing an entry in the log based on a timestamp corresponding to the entry or based on an amount of change in a position compared to a preceding entry.

7. The system of claim 5, wherein the validating of the generated one or more candidate segments comprises validating the first candidate segment and the second candidate segment against each other based on lateral distances between corresponding pairs of points of the first candidate segment and the second candidate segment.

8. The system of claim 1, wherein the validating of the generated one or more candidate segments comprises validating the third candidate segment based on a quality of the third candidate segment, the quality being determined based on a length, a degree of smoothness and a frequency of oscillations of the third candidate segment.

9. The system of claim 1, wherein the constructing of the segment comprises constructing portions of the segment based on a highest ranked validated candidate segment that is available within each of the portions, the highest ranked validated candidate segment being selected from the validated first candidate segment, the validated second candidate segment, and the validated

10. The system of claim 1, wherein the instructions further cause the one or more processors to perform computing a navigation path for the ego vehicle based on a restriction of the ego-vehicle operating within boundaries defined by the constructed segment and actuating the ego-vehicle based on the navigation path.

11. A method comprising:
obtaining data from a plurality of sources, wherein the plurality of sources comprise any of low resolution map data, historical data of an ego-vehicle position, and landmark data;
generating one or more candidate segments indicative of potential lane boundaries, the candidate segments comprising any of a first candidate segment generated from the low resolution map data, a second candidate segment generated from the historical data of the ego-vehicle position, and a third candidate segment generated from the landmark data;
validating the generated one or more candidate segments;
aligning the validated and generated one or more candidate segments;
constructing a segment based on the aligned, validated, and generated one or more candidate segments, the segment defining a lane boundary, wherein the segment is used to compute a navigation path for the ego-vehicle to operate the ego-vehicle within the lane boundary defined by the segment.

12. The method of claim 11, wherein the validating of the generated one or more candidate segments comprises filtering out or removing any first candidate segment in which a radius of curvature, occurring anywhere within the first candidate segment, is lower than a first threshold radius of curvature.

13. The method of claim 11, wherein the generating of the one or more candidate segments comprises defining the generated one or more candidate segments in terms of a relationship between a longitudinal position and a latitudinal position.

14. The method of claim 11, wherein the validating of the generated one or more candidate segments comprises determining any first candidate segment that has a concave down portion and a concave up portion, in which radii of curvature within both the concave down portion and the concave up portion are less than a second threshold radius of curvature; and filtering out or removing the concave down portion and the concave up portion.

15. The method of claim 12, wherein the generating of the one or more candidate segments comprises:
logging, within a log, one or more entries corresponding to historical positions traversed by the ego-vehicle, the historical positions defined according to a latitude and a longitude; and
generating the second candidate segment based on the logged one or more entries.

16. The method of claim 15, wherein the generating of the one or more candidate segment further comprises selectively removing an entry in the log based on a timestamp corresponding to the entry or based on an amount of change in a position compared to a preceding entry.

17. The method of claim 15, wherein the validating of the generated one or more candidate segments comprises validating the first candidate segment and the second candidate segment against each other based on lateral distances between corresponding pairs of points of the first candidate segment and the second candidate segment.

18. The method of claim 11, wherein the validating of the generated one or more candidate segments comprises validating the third candidate segment based on a quality of the third candidate segment, the quality being determined based on a length, a degree of smoothness and a frequency of oscillations of the third candidate segment.

19. The method of claim 11, wherein the constructing of the segment comprises constructing portions of the segment based on a highest ranked validated candidate segment that is available within each of the portions, the highest ranked validated candidate segment being selected from the validated first candidate segment, the validated second candidate segment, and the validated third candidate segment.

20. The method of claim 11, further comprising computing a navigation path for the ego vehicle based on a restriction of the ego-vehicle operating within boundaries defined by the constructed segment and actuating the ego-vehicle based on the navigation path.
